(19) United States
(12) Patent Application Publication
(10) Pub. No.: US 2011/0039087 A1
(43) Pub. Date: Feb. 17, 2011

(54) Emulsions Of Dilatant Organopolysiloxanes

(76) Inventors: Severine Cauvin, Braine-Le-Comte (BE); Donald Liles, Midland, MI (US); Steven Robson, Vale of Glamorgan (GB); Andreas Stammer, Pont-A-Celles (BE)

Correspondence Address: DOW CORNING CORPORATION CO1232, 2200 W. SALZBURG ROAD, P.O. BOX 994, MIDLAND, MI, 48686-0994, US

(21) Appl. No.: 12/937,729

(22) PCT Filed: Apr. 13, 2009
(86) PCT No.: PCT/US09/40354

§ 371 Date: Oct. 14, 2010

Related U.S. Application Data
(60) Provisional application No. 61/044,594, filed on Apr. 14, 2008.
(60) Provisional application No. 61/044,597, filed on Apr. 14, 2008.
(60) Provisional application No. 61/140,109, filed on Dec. 23, 2008.

(51) Int. Cl. C09D 183/04; B32B 5/02

(52) U.S. Cl. 428/221; 524/588

(57) ABSTRACT

Emulsions are disclosed of dilatant boron crosslinked organopolysiloxanes, coatings prepared from the emulsions, and various substrates impregnated with these coatings. The emulsions may be coated or impregnated onto fabrics to provide an energy absorbing material in Active Protection Systems.

### CROSS REFERENCE TO RELATED APPLICATIONS

This application claims the benefit of U.S. Provisional Patent Application No. 61/044,597 filed Apr. 14, 2008, U.S. Provisional Patent Application No. 61/044,594 filed Apr. 14, 2008, and U.S. Provisional Patent Application 61/140,109 filed Dec. 23, 2008.

### TECHNICAL FIELD

This disclosure relates to emulsions of dilatant boron crosslinked organopolysiloxanes, coatings prepared from the emulsions, and various substrates impregnated with these coatings. The emulsions may be coated or impregnated onto fabrics to provide an energy absorbing material in Active Protection Systems.

### BACKGROUND

Boron crosslinked organopolysiloxanes have found use as energy absorbing materials because of their dilatant properties. For example, dilatant boron crosslinked silicones are used in Active Protection Systems (APS) wherein a fabric is coated with a boron crosslinked silicone.

GB-A-890007, U.S. Pat. No. 2,431,898 and GB-A-1387040 each describe a dilatant silicone composition.

WO 00/69293 and WO-A-03/022085 describe a flexible energy absorbing material in which a dilatant material is impregnated into a flexible carrier such as a fabric or foam. The dilatant material remains soft until it is subjected to an impact, when its characteristics change rendering it temporarily rigid. The dilatant material returns to its normal flexible state after the impact. The flexible energy absorbing material can be worn as impact protection, for example as clothing for motorcycling or skiing or as knee or elbow pads for roller skating or skateboarding.

JP-A-4-257439 and JP-A-4-257440 each describe a woven or unwoven cloth coated with or impregnated with heat-resistant paint consisting of polyborosiloxane, a silicone resin, an inorganic filling material and a short-fibrous inorganic filling material or glass frit.

WO 2007/102020 describes an impregnated flexible sheet material, for example a fabric, and to a process for impregnating a flexible sheet material. In particular it relates to a flexible sheet material impregnated with a dilatant silicone composition useful as an energy absorbing material.

However, the aforementioned references require the boron crosslinked silicone be first dispersed or dissolved in an organic solvent. Water based emulsions of boron crosslinked silicones would be easier to use and environmentally more desirable in such processes. Thus, a need exists to provide emulsions of boron crosslinked silicones having dilatant properties for coating or impregnating fabrics for use in Active Protection Systems.

There are few examples of emulsions of boron crosslinked silicones or borosiloxanes. Presumably, the interaction of a boron crosslinker with water has limited this crosslinking chemistry in a water based composition.

U.S. Pat. No. 4,863,985 teaches aqueous silicone emulsions cross-linkable into an elastomeric state. In particular, U.S. Pat. No. 4,863,985 discloses thixotropic silicone emulsions cross-linkable into elastomeric state upon removal of water therefrom, e.g., to fabricate elastomer seals for the construction industry, have a pH of from 4 to 8 and a solids content of at least 50%, and contain: (A) 100 parts of an oil-in-water emulsion of an α,ω-(dihydroxy)polydiorganosiloxane, and a stabilizing amount of at least one anionic or nonionic surface-active agent, or mixture thereof; (B) 1 to 15 parts of a siliceous reinforcing filler in powder form; (C) 0 to 250 parts of an inorganic filler other than the siliceous filler (B); (D) 0.01 to 2 parts of a catalytic tin compound; and (E) 0.1 to 5 parts of boric oxide, a boric acid or a borate. While U.S. Pat. No. 4,863,985 teaches emulsions of silicones that provide elastomeric silicones, the addition of tin and fillers are necessary in these compositions.

### SUMMARY

The present inventors have discovered emulsions of boron crosslinked organopolysiloxanes having dilatant properties. In particular, the present disclosure provides emulsions of boron crosslinked organopolysiloxanes that yield coatings having dilatant properties upon drying. The emulsions may be used on substrates such as foams, fibers, non-woven materials, laminates, composites, and knitted or woven fabrics, as the energy absorbing material in Active Protection Systems.

### DETAILED DESCRIPTION

The present disclosure relates to emulsions compositions of a dilatant boron crosslinked organopolysiloxane. As used herein “dilatant” refers to the rheological properties exhibited by the boron crosslinked organopolysiloxane in the disclosed emulsions, or more particularly to the subsequent coatings produced from these emulsions.

The emulsion compositions of the present disclosure may be an oil/water emulsion, a water/oil emulsion, a multiple phase or triple emulsion.

In one embodiment, the emulsion composition is a water continuous emulsion having a dispersed phase comprising the boron crosslinked organopolysiloxane (that is, an oil/water emulsion). The oil/water emulsion may be characterized by average volume particle of the dispersed boron crosslinked organopolysiloxane phase in a continuous aqueous phase. The particle size may be determined by laser diffraction of the emulsion. Suitable laser diffraction techniques are well known in the art. The particle size is obtained from a particle size distribution (PSD). The PSD can be determined on a volume, surface, length basis. The volume particle size is equal to the diameter of the sphere that has the same volume as a given particle. The term Dv represents the average volume particle size of the dispersed particles. Dv 0.5 is the particle size measured in volume corresponding to 50% of the cumulative particle population. In other words if Dv 0.5=10 μm, 50% of the particle have an average volume particle size below 10 μm and 50% of the particle have a volume average particle size above 10 μm. Unless indicated otherwise all average volume particle sizes are calculated using Dv 0.5.

The average volume particle size of the dispersed siloxane particles in the oil/water emulsions is between 0.1 μm and 150 μm; or between 0.1 μm and 10 μm; or between 0.5 μm and 1.0 μm.

Other additives can also be incorporated in the emulsions of the present disclosure, such as fillers, foam control agents; anti-freeze agents and biocides.

In one embodiment, the emulsion compositions of the present disclosure contains a reaction product from;
A) a silanol functional organopolysiloxane and
B) a boron compound,
   and further contains
C) an emulsifier.

In yet another embodiment, at least 70 percent of the silanol functional groups of component A) are reacted with the boron compound B) to form the boron crosslinked organopolysiloxane present in the dispersed particles. The extent of this reaction, (i.e. the formation of boron siloxane ester) can be confirmed using various analytical techniques such as ²⁹Si NMR spectroscopy.

### A) The Silanol Functional Organopolysiloxane

Organopolysiloxanes are polymers containing siloxane units independently selected from (R₃SiO_{0.5}), (R₂SiO), (RSiO_{1.5}), or (SiO₂) siloxy units, where R may independently be an organic group, OH (silanol), or H (SiH functional). These siloxy units are commonly referred to as M, D, T, and Q units respectively. These siloxy units can be combined in various manners to form cyclic, linear, or branched structures. The chemical and physical properties of the resulting polymeric structures will vary depending on the type and number of each siloxy units present in the organopolysiloxane. For example organopolysiloxanes can be volatile or low viscosity fluids, high viscosity fluids/gums, elastomers or rubbers, and resins.

The organopolysiloxane useful as component A) in the present invention may have any combination of (R₃SiO_{0.5}), (R₂SiO), (RSiO_{1.5}), or (SiO₂) siloxy units, providing the organopolysiloxane contains at least one silanol group (SiOH). Thus, the organopolysiloxane may have varying molecular weights and be a liquid, a gum, an elastomer, a resin, or any combination thereof. For example, the organopolysiloxane may be a mixture of a higher molecular weight organopolysiloxane (such as an elastomer or resin) in a lower molecular weight liquid organopolysiloxane, providing there is at least one silanol group in the organopolysiloxane composition of component A.

The amount of silanol groups present in the organopolysiloxane may vary. The amount of silanol groups in the organopolysiloxane may be designated as weight percent of SiOH. The weight percent of silanol groups that are typical in the organopolysiloxanes useful as component A) vary from 0.01 to 20 weight percent, alternatively from 0.05 to 10 weight percent, alternatively from 0.05 to 4 weight percent.

In one embodiment, the organopolysiloxane is a predominately linear polydimethylsiloxane having terminal silanol groups. The predominately linear polydimethylsiloxane having terminal silanol groups may have the formula;

HO(Me)₂SiO[(Me)₂SiO]ₓ(Me)₂SiOH

where x is >0, alternatively, x is 1-4000, alternatively 10-1000.

In yet another embodiment, the silanol functional organopolysiloxane may be mixed with other silane or polysiloxane components before or during mixing with components B) and C), as described below. The other silane or siloxane components include organofunctional silanes or organofunctional polysiloxanes that can react with the silanol functional organopolysiloxane. Suitable organofunctional silanes include amino functional silanes such as;
aminopropyl trimethoxysilane,
ethylenediaminepropyl trimethoxysilane, or
ethylenediamineisobutyl trimethoxysilane.

Suitable organofunctional polysiloxanes include amino functional organopolysiloxanes such as those having a formula

R²R₂SiO(R₂SiO)ₐ(R¹RSiO)_{b}SiR₂R² or

R²R₂SiO(R₂SiO)ₐ(R¹SiO)_{3/2})_{b}SiR₂R²

wherein R is a monovalent organic group, R¹ is an aminoalkyl group having its formula selected from the group consisting of —R³NH₂ and —R³NHR⁴NH₂ wherein R³ is a divalent hydrocarbon group having at least 3 carbon atoms and R⁴ is a divalent hydrocarbon group having at least 2 carbon atoms, R² is R, R¹, or OH, a has a value of 0 to 2000, and b has a value of from greater than zero to 200. The monovalent R groups are exemplified by alkyl groups such as the methyl, ethyl, propyl, butyl, amyl, and hexyl; alkenyl groups such as the vinyl, allyl, and hexenyl; cycloalkyl groups such as the cyclobutyl and cyclohexyl; aryl groups such as the phenyl and naphthyl; aralkyl groups such as the benzyl and 2-phenylethyl; alkaryl groups such as the tolyl, and xylyl; halohydrocarbon groups such as 3-chloropropyl, 4-bromobutyl, 3,3,3-trifluoropropyl, chlorocyclohexyl, bromophenyl, and chlorophenyl. Typically R is a monovalent hydrocarbon group having from 1 to 6 carbon atoms. Especially preferred R groups are methyl, phenyl, and vinyl. The group R³ is typically an alkylene group having from 3 to 20 carbon atoms. Typically R³ is selected from propylene, —CH₂CHCH₃—, butylene, —CH₂CH(CH₃)CH₂—, pentamethylene, hexamethylene, 3-ethyl-hexamethylene, octamethylene, and decamethylene. The group R⁴ is typically an alkylene group having from 2 to 20 carbon atoms. Typically R⁴ is selected from ethylene, propylene, —CH₂CHCH₃—, butylene, —CH₂CH(CH₃)CH₂—, pentamethylene, hexamethylene, 3-ethyl-hexamethylene, octamethylene, and decamethylene. R¹ typically is —CH₂CH₂CH₂NHCH₂CH₂NH₂ or —CH₂CH(CH₃)CH₂NHCH₂CH₂NH₂. Salts of these same aminofunctional groups may also be used. Examples of such salts include alkyl carboxylate salts, aryl carboxylate salts, halide salts such as chlorides and bromides, and other neutralization products of the amines with organic acids. Although the group R² may be R, R¹, or —OH, typically R² is methyl or —OH. The polyorganosiloxanes may have from 0.1 to 15 molar percent of the above described amino groups and most typically from 0.2 to 10 molar percent of the above described amino groups. In the above formulas, typically a has a value of from 50 to 2000, and b has a value of 1 to 100. The aminofunctional polyorganosiloxanes useful in this invention can be prepared by procedures well known in the art. Many of these polyorganosiloxanes are available commercially.

The amount of the silanol functional organopolysiloxane added may vary. The amount used will depend on the type and amount of boron compound used) and the extent of crosslinking desired. Typically, the amount of the silanol functional organopolysiloxane ranges from 50 to 99, alternatively from 75 to 95, alternatively from 85 to 90 weight, percent based on the total weight of the mixture of A), B), and C).

### B) The Boron Compound

Component B) is a boron compound. As used herein, a “boron compound” means any compound containing boron. Any boron compound known to react with organopolysiloxanes may be selected as component B). Alternatively, the boron compound may be selected from those known to react with silanol functional groups on organopolysiloxanes. Such boron compounds include; boron or boric oxide, boric acid, borates, boric anhydride. Boric acid may be orthoboric acid, metaboric acid, or tetraboric acid. Borates include alkyl and allyl boric acid esters/triorganoborates that hydrolyse to boric acid in the presence of water, such as triethylborate, triphenylborate, tribenzyl borate, tricyclohexyl borate, tri(methylsilyl)borate, tri-t-butyl borate, trialkoxyboroxines such as trimethoxyboroxine and triisopropoxyboroxine, triethanolamineborate, and derivatives such as 2,2′-oxybis[4,4,6-trimethyl-1,3,2-dioxaboranine. Borates also encompass inorganic borates such as diammonium pentaborate, sodium tetraborate decahydrate (borax), potassium pentaborate, magnesium diborate, calcium monoborate, barium triborate, and zinc metaborate. Suitable boron compounds further includes the partial hydrolysis products of the aforementioned borates. Typically, the boron compound is boron oxide having the formula B₂O₃ [CAS registry #1303-86-2], or boric acid having the formula H₃BO₃ [CAS registry #10043-35-3].

The boron compound may be added either alone or in combination with other ingredients.

In one embodiment, the boron compound is boric acid (H₃BO₃), and is dispersed in a trimethoxy terminated polydimethylsiloxane, such as Dow Corning® 200 fluid having a viscosity ranging from 0.65 cS (mm²/s) at 25° C. to 100,000 cS (mm²/s) at 25° C., alternatively from 100 to 10,000 cS (mm²/s) at 25° C., or alternatively from 100 to 10,000 cS (mm²/s) at 25° C.

The amount of boric acid dispersed in the trimethoxy terminated polydimethylsiloxane may vary, but typically ranges from 0.5 to 70, alternatively from 10 to 50 weight percent alternatively from 40 to 50 weight percent.

The amount of boron compound added may vary. The amount used will depend on the type and amount of organopolysiloxane used and the extent of crosslinking desired. Typically, the amount of boron compound ranges from 0.05 to 30, alternatively from 0.1 to 10 alternatively from 0.1 to 6 weight percent based on mixture of A), B), and C).

### C) The Emulsifier

Component C is an emulsifier. As used herein, “emulsifier” refers to any compound or substance that enables the formation of an emulsion. The emulsion may be an oil/water emulsion, a water/oil emulsion, a multiple phase or triple emulsion. The emulsifier may be selected from any surface active compound or polymer capable of stabilizing emulsions. Typically, such surface active compounds or polymers stabilize emulsions by preventing coalescence of the dispersed particles. The surface active compounds useful as emulsifiers in the present process may be a surfactant or combination of surfactants. The surfactant may be an anionic surfactant, cationic surfactant, nonionic surfactant, amphoteric surfactant, or a mixture of any of these surfactants.

Representative examples of suitable anionic surfactants include alkali metal soaps of higher fatty acids, alkylaryl sulphonates such as sodium dodecyl benzene sulphonate, long chain fatty alcohol sulphates, olefin sulphates and olefin sulphonates, sulphated monoglycerides, sulphated esters, sulphonated ethoxylated alcohols, sulphosuccinates, alkane sulphonates, phosphate esters, alkyl isethionates, alkyl taurates, and alkyl sarcosinates.

Representative examples of suitable cationic surfactants include alkylamine salts, quaternary ammonium salts, sulphonium salts, and phosphonium salts. Representative examples of suitable nonionic surfactants include condensates of ethylene oxide with long chain fatty alcohols or fatty acids such as a C₁₂₋₁₆ alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, and fatty amine oxides. Representative examples of suitable amphoteric surfactants include imidazoline compounds, alkylaminoacid salts, and betaines.

Representative examples of suitable commercially available nonionic surfactants include polyoxyethylene fatty alcohols sold under the tradename BRIJ® by Uniqema (ICI Surfactants), Wilmington, Del. Some examples are BRIJ® 35 Liquid, an ethoxylated alcohol known as polyoxyethylene (23) lauryl ether, and BRIJ® 30, another ethoxylated alcohol known as polyoxyethylene (4) lauryl ether. Some additional nonionic surfactants include ethoxylated alcohols sold under the trademark TERGITOL® by The Dow Chemical Company, Midland, Mich. Some example are TERGITOL® TMN-6, an ethoxylated alcohol known as ethoxylated trimethylnonanol; and various of the ethoxylated alcohols, i.e., C₁₂-C₁₄ secondary alcohol ethoxylates, sold under the trademarks TERGITOL® 15-S-5, TERGITOL® 15-S-12, TERGITOL® 15-S-15, and TERGITOL® 15-S-40. Lutensol® supplied by BASF in the series of Lutensol XP known as ethoxylated, C10-Guerbet alcohol and Lutensol TO known as ethoxylated, iso-C13 alcohol may also be used.

When mixtures containing nonionic surfactants are used, one nonionic surfactant may have a low Hydrophile-Lipophile Balance (HLB) and the other nonionic surfactant may have a high HLB, such that the two nonionic surfactants have a combined HLB of 11-15, alternatively a combined HLB of 12.5-14.5.

Alternatively, the emulsifier may be a polymer or those materials consider as “thickeners” or “thickening agents”. Such polymeric emulsifiers include polyvinyl alcohol, cellulosic polymers or xanthan gums. The polyvinyl alcohol includes hydrolyzed polyvinyl alcohols, such as 80-95% hydrolyzed polyvinyl alcohol. Suitable thickening agents are exemplified by sodium alginate, gum arabic, polyoxyethylene, guar gum, hydroxypropyl guar gum, ethoxylated alcohols, such as laureth-4 or polyethylene glycol 400, cellulose derivatives exemplified by carboxy methylcellulose, methylcellulose, methylhydroxypropylcellulose, hydroxypropylcellulose, polypropylhydroxyethylcellulose, starch, and starch derivatives exemplified by hydroxyethylamylose and starch amylose, locust bean gum, electrolytes exemplified by sodium chloride and ammonium chloride, and saccharides such as fructose and glucose, and derivatives of saccharides such as PEG-120 methyl glucose diolate or mixtures of 2 or more of these. Typically the thickening agent is selected from the group consisting of cellulose derivatives, saccharide derivatives, and electrolytes, or from a combination of two or more of the above thickening agents exemplified by a combination of a cellulose derivative and any electrolyte, and a starch derivative and any electrolyte.

The emulsifier may be added either alone or in combination with varying amounts of water. Typically, when a surfactant or surfactant combination is selected as the emulsifier, the surfactant is added as a concentrated aqueous dispersion, or alternatively as an aqueous solution.

In one embodiment, the emulsifier is an aqueous solution containing at least 70 weight percent of two nonionic surfactants having a combined HLB of 8-15.

Alternatively the emulsifier is an aqueous solution of 5 to 30 weight percent of nonionic surfactant having alone a HLB of 8 to 15, or the emulsifier is an aqueous solution containing at least 20 weight percent of one nonionic surfactant and a cationic surfactant, or the emulsifier is an aqueous surfactant containing 30 to 100 weight percent of a anionic surfactant.

The amount of emulsifier added may vary. The amount used will depend on the type of emulsion and the particle size desired. Typically, the amount of emulsifier added in Step I is 0.1 to 40, alternatively the amount is 0.5 to 30 weight percent of the mixture of A), B), and C).

The emulsion compositions of the present disclosure may be prepared by any method known in the art. Alternatively, the emulsion compositions may be prepared by the process described below according to one embodiment of the present invention.

The first step of the process involves forming a mixture of;
A) the silanol functional organopolysiloxane,
B) the boron compound, and
C) the emulsifier,
   where components A), B) and C) are as described above.

Mixing in step (I) can be accomplished by any method known in the art to affect mixing of high viscosity materials. The mixing may occur either as a batch, semi-continuous, or continuous process. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, co-rotating extruders, such as those manufactured by Krupp Werner & Pfleiderer Corp (Ramsey, N.J.), and Leistritz (NJ); twin-screw counter-rotating extruders, two-stage extruders, twin-rotor continuous mixers, dynamic or static mixers or combinations of these equipments.

The temperature and pressure at which the mixing of step I occurs is not critical, but generally is conducted at ambient temperature and pressures. Typically, the temperature of the mixture will increase during the mixing process due to the mechanical energy associated with shearing such high viscosity materials.

Although not wishing to be bound by any theory, the present inventors believe that as a result of mixing components A), B), and C) the boron compound reacts with the silanol functional organopolysiloxane to form various crosslinks. However, the inclusion of an emulsifier in the step I) mixture enhances subsequent emulsion formation in step II).

Step II of the process involves admixing water to the mixture of step I to form an emulsion. Typically 5 to 45 parts water are mixed for every 100 parts of the step I mixture to form an emulsion. In one embodiment the emulsion formed is a water continuous emulsion. Typically, the water continuous emulsion has dispersed particles of the boron crosslinked organopolysiloxane from step I, and having an average particle size less than 150 μm.

The amount of water added can vary from 5 to 45 parts per 100 parts by weight of the premix. The water is added to the mixture from step I at such a rate so as to form an emulsion of the mixture of step I. While this amount of water can vary depending on the selection of the boron oxide crosslinked organopolysiloxane and emulsifier, generally the amount of water is from 5 to 45 parts per 100 parts by weight of the step I mixture, alternatively from 5 to 30 parts per 100 parts by weight of the step I mixture, or alternatively from 5 to 20 parts per 100 parts by weight of the step I mixture.

Typically the water is added to the mixture from step I in incremental portions, whereby each incremental portion comprises less than 8 weight % of the mixture from step I and each incremental portion of water is added successively to the previous after the dispersion of the previous incremental portion of water, wherein sufficient incremental portions of water are added to form an emulsion of the boron oxide crosslinked organopolysiloxane.

Mixing in step (II) can be accomplished by any method known in the art to affect mixing of high viscosity materials. The mixing may occur either as a batch, semi-continuous, or continuous process. Any of the mixing methods as described for step (I), may be used to affect mixing in step (II).

Optionally, the water continuous emulsion formed in step (II) may be further sheared according to step (III) to reduce particle size and/or improve long term storage stability. The shearing may occur by any of the mixing techniques discussed above.

The emulsions of the present disclosure may contain additional components and auxiliaries to effect the physical properties of the emulsions. These include, but not limited to biocides, antifreeze agents, and various fillers.

In one embodiment, silica is added to the emulsion to affect subsequent properties, and in particular dilatant properties. The amount and type of silica added to the emulsion may vary. Typically, the amount of silica added to the emulsion may vary from 0.1 to 50 weight percent, alternatively, 1 to 40 weight percent, or alternatively 5 to 30 weight percent may be added to the emulsion. The silica may be added at any time during the processing of the emulsion, but typically is post added. That is, the emulsion is first prepared, and then the colloidal silica is added to the prepared emulsion.

Suitable silicas include fumed silicas such as AEROSIL® OX-50 (40 nanometer average particle diameter silica available from Evonik); stabilized silica sols such as the KLEBOSOL® Series available from Rohm and Haas), KLEBOSOL® 30H25 (25 nm average particle diameter proton stabilized waterborne colloidal silica sol having a ph of 2.2 and a 30% solids content, KLEBOSOL 30HSO (50 nm average particle diameter proton stabilized waterborne colloidal silica sol having a pH of 2.5 to 3.0 and a 30% solids content, KLEBOSOL 30N12 (12 nm average particle diameter ammonium ion stabilized waterborne colloidal silica sol having a pH of 9.5 to 10.5 and a 30% solids content, KLEBOSOL 30N25 (25 nm average particle diameter ammonium ion stabilized waterborne colloidal silica sol having a pH of 9.6 and a 30% solids content, NALCO® 1034A (20 nanometer average particle diameter acidic colloidal silica sol having a pH of 2.8 and a 34% solids content, available from Nalco Chemical Co.), NALCO 1130 (8 nanometer average particle diameter alkaline colloidal silica sol having a pH of 10.0 and a 30% solids content, available from Nalco Chemical Co.) and NALCO 1140 (15 nanometer average particle diameter alkaline colloidal silica sol having a pH of 9.4 and a 40% solids content, available from Nalco Chemical Co.). Suitable colloidal silicas include the LUDOX® series from W.R. Grace such as; LUDOX AM, LUDOX AM-30 (12 nm average particle diameter aqueous silica sol having a 30% solids content), LUDOX AS, LUDOX HS40, LUDOX LS, LUDOX TM and LUDOX TMA (22 nm average particle diameter aqueous silica sol having a 34% solids:content). Another suitable silica includes those marketed as SNOWTEX® colloidal silicas from Nissan Chemical (Houston, Tex.), such as SNOWTEX.

The emulsions of the present disclosure may be further characterized by the properties of the resulting films or coatings produced after allowing a film of the emulsion to dry. Typically, such coatings are obtained by forming a film of the emulsion, and allowing the film to stand for a sufficient period of time to evaporate the water present in the emulsion. This process may be accelerated by increasing the ambient temperature of the film or coating.

The coatings resulting from the present emulsions may by characterized by their rheological properties, such as with a shear rotational rheometer (for example a Carri-Med or ARES rheometer from TA Instruments) to determine both the storage (G′) and loss modulus (G″). Upon drying a film of the boron crosslinked organopolysiloxane emulsion to produce a coating, G′ is at least 200 Pa and a G″ is at least 1000 Pa at 25° for the resulting coatings. Typically,
G′ ranges from 200 Pa to 10,000,000 Pa
   alternatively, G′ ranges from 1000 Pa to 200,000 Pa;
G″ ranges from 1000 Pa to 10,000,000 Pa
   alternatively, G″ ranges from 1000 Pa to 200,000 Pa
      for the resulting silicone coating at 25° C.

The emulsions of the present disclosure may be applied to a variety of substrates to form finished articles of manufacture having a coating with dilatant properties. Exemplary substrates include; foams, fibers, non-woven materials, laminates, composites, flexible sheet materials, and knitted or woven fabrics.

Exemplary fabrics and textiles that can be treated with the dilatant emulsion composition include natural fibers such as cotton, silk, linen, and wool; regenerated fibers such as rayon and acetate; synthetic fibers such as polyesters, polyamides, polyacrylonitriles, polyethylenes, and polypropylenes; combinations, and blends thereof. The form of the fibers can include threads, filaments, tows, yarns, woven fabrics, knitted materials, non-woven materials, paper, carpet, and leather.

The present disclosure also provides a method for applying to fabrics or textiles the dilatant emulsions as a treatment composition. When the treatment composition comprises more than one solution, dispersion, or emulsion; the solutions, dispersions, and emulsions can be applied simultaneously or sequentially to fabrics. After the treatment composition is applied to the fabric, it can be dried by heat.

The dilatant emulsion composition can be applied to a flexible sheet material by any of the processes known for impregnating flexible sheet materials such as fabrics. Examples are padding, dipping, spraying, application by rollers, curtain coating, knife coating or screen printing. Dipping of the fabric in a bath of the composition to be applied, followed by squeezing between rollers to control the amount of composition taken up by the fabric or other sheet material, is one suitable process. After impregnation the fabric or other sheet material is dried, either by allowing the fabric to dry under ambient conditions or by applying heat and/or a current of a drying gas such as air to accelerate drying. Drying can for example be carried out at 40 to 200° C., particularly 60 to 120° C. If the flexible sheet material is impregnated with the dilatant silicone composition and is then treated another composition, the flexible sheet material may be dried after impregnation with the dilatant silicone composition or the two composition can be applied successively without an intermediate drying step.

The treatment composition containing the dilatant emulsion can be applied to the fabric and/or textile during making the fabrics or textiles, or later in subsequent treatment processes. After application, carriers (if any) can be removed from the treatment composition for example by drying the composition at ambient or elevated temperature.

The amount of the dilatant emulsion composition applied to the fabric or textiles may vary, but typically is sufficient to provide a dried coating (that is add on weight after drying) of 200 to 4000 g/m², alternatively 400 to 3000 g/m², or alternatively 600 to 2000 g/m².

In one embodiment, the emulsions of the present disclosure may be used to provide a coating composition useful as an energy absorbing material. For example, the disclosed emulsions may be used in any of the constructions of energy absorbing material based on fabric or other flexible sheet material described in WO 00/69293 or WO-A-03/022085. Impregnated fabrics according to the invention are particularly suitable for energy absorbing garments for potentially dangerous sports such as motorcycling, skiing, skating, skateboarding, snowboarding, mountain biking, cycling, rugby, football, soccer, cricket, lacrosse, hurling, equestrianism, polo, baseball, golf, boxing, martial arts, gymnastics and athletics. There is also potential for use in flexible personal protective equipment used in industrial, manufacturing and construction applications. Such materials also show potential in high-speed/ballistic protection and may find application in law enforcement and defense (civil and armed forces).

This disclosure further relates to fabrics containing coatings of the dilatant emulsions. The coated fabrics are particularly useful in Active Protection Systems. The coated fabrics treated with the present dilatant emulsions may be characterized by their impact attenuation. Impact attenuation may be assessed according to a variety of EN standards (from CEN, the European Committee for Standardization http://www.cen.eu/cenorm/homepage.htm) such as EN1621-1:1997, EN1621-2:2003, EN13061:2002, EN13158:2000, EN13546:2002, EN13277:2002. However, for purposes of this disclosure, the impact attenuation of the coated fabrics was evaluated according to test methods of EN1621-2:1997 which is a “drop-tower” test. According to EN1621-2:1997, a test piece of precise mass and dimensions is dropped from height onto the sample being tested which itself sits upon a force transducer system of precise dimensions and configuration. The kinetic energy specified in the standard is controlled according to the mass and velocity of the moving test piece. The force transmitted through the sample is measured by a piezoelectric detector inside the force transducer that is electronically sampled to produce a record of transmitted force against time. The peak value of this transmitted force is the critical measure of performance, where better performance is usually indicated by lower transmitted peak force.

The fabrics containing the dried coatings of the present dilatant emulsions provide impact attenuation values that are comparable to those fabrics coated with silicone compositions in organic solvents. For example, a knitted spacer polyester fabric having between a dried coating of the boron crosslinked organopolysiloxane deposited on it from a representative dilatant emulsion, produces a fabric having impact attenuation values of less than 50 kN peak transmitted force, alternatively less than 30 kN peak transmitted force according to EN1621-1 or EN1621-2 impact tests performed with impact energy of 50 J.

### Examples

These examples are intended to illustrate the invention to one of ordinary skill in the art and should not be interpreted as limiting the scope of the invention set forth in the claims. All measurements and experiments were conducted at 23° C., unless indicated otherwise.

Mean particle size was determined using a Malvern Mastersizer 2000. Rheological properties were determined using a TA Instruments ARES rheometer equipped with cone-and-plate geometry (Examples 1 to 5) and a Carri-Med Rheometer CSL² with a cone-and-plate geometry (Example 6 to 14).

### Example 1

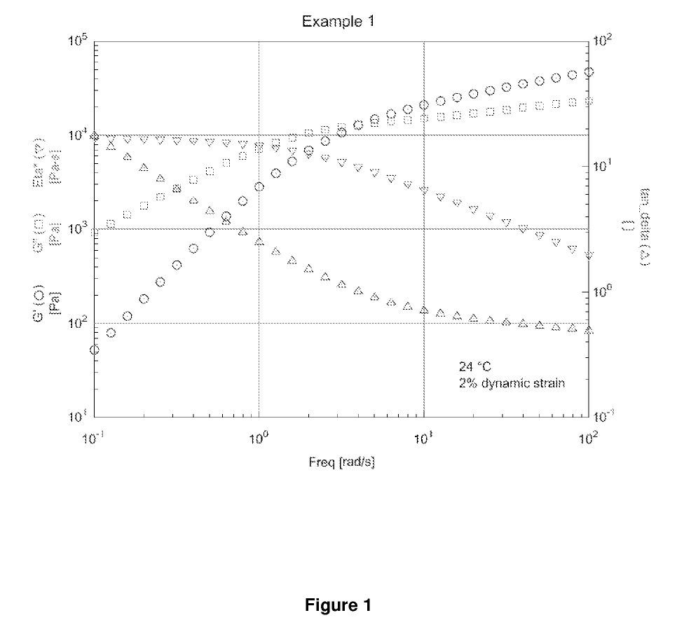

First, 50 g of a Me₂SiOH terminated dimethylpolysiloxane having a viscosity of approximately 50,000 mPa sec. (cP) and a number average molecular weight of approximately 61,000 was weighed into a max 100 cup followed by 0.10 g of a 50% by weight dispersion of boric acid in trimethylsiloxy-capped polydimethylsiloxane fluid having an approximate kinematic viscosity of 1000 cSt. The cup was closed and placed into a Speedmixer® DAC 150 mixer and the cup was spun for 20 seconds at maximum speed. The cup was allowed to remain undisturbed for 15 minutes after which it was spun again for 20 seconds at maximum speed. After an additional 10 minutes at rest, the cup was spun again for 20 seconds. Immediately following the previous spinning, 0.75 g of lauryl alcohol (4) ethoxylate (Brij® 30) was added followed by 1.5 g of a 72% aqueous solution of lauryl alcohol (23) ethoxylate (Brij® 35 L) and 0.60 g of deionized (DI) water. The cup was closed and spun in the Speedmixer® for 20 seconds. The contents of the cup had formed a mass having a thick gel-like consistence and the walls of the cup were scraped with a spatula. The cup and its contents were spun again for 20 seconds. The thick phase composition was diluted incrementally with a total of 31 g of DI water. The first increment was 5 g followed by another 5 g then 10 g followed with a final 11 g. The cup was spun for 18 seconds at full speed in the SpeedMixer® after each incremental addition of water. The resulting final composition was a milky-white liquid of low viscosity and consisted of an oil/water emulsion of approximately 60% by weight polydimethylsiloxane containing boron oxide and having a mean particle size of approximately 0.75 μm. The following day, a 20 g portion of the emulsion was poured into a Petri dish and allowed to evaporate and at ambient conditions for 24 hours. The resulting polymer from the emulsion was inspected and found to have increased in viscosity substantially from that of the starting silicone polymer. Viscosity of the polymer from the emulsion was determined using a rheometer and found to have a zero-shear-rate viscosity of approximately 10⁷ cP (@ 10⁻¹ sec.⁻¹ & 24° C.), as summarized in FIG. 1. These results show the viscosity of the siloxane polymer from the emulsion was significantly higher than the viscosity of the starting siloxane polymer (approximately 5×10⁴ cP).

### Example 2

Using the same procedure as described in Example 1, a composition prepared from 50 g of a Me₂SiOH terminated dimethylpolysiloxane having a viscosity of approximately 50,000 mPa sec. (cP) and a number average molecular weight of approximately 61,000, 0.11 g of a 50% by weight dispersion of boric acid in trimethylsiloxy-capped polydimethylsiloxane fluid having an approximate kinematic viscosity of 1000 cSt was emulsified using 0.75 g of lauryl alcohol (4) ethoxylate (Brij® 30, 1.5 g of a 72% aqueous solution of lauryl alcohol (23) ethoxylate (Brij® 35 L) and 0.60 g of deionized (DI) water. The emulsion thick phase was diluted incrementally with a total of 31 g of DI water using the same procedure of example 1. Mean particle size of the emulsion was approximately 0.75 μm.

### Example 3

Using the same procedure and quantities as described in Example 2 except for the amount of boron oxide dispersion in polydimethylsiloxane used, an emulsion was prepared. This emulsion was prepared using 50 g of a Me₂SiOH terminated dimethylpolysiloxane and 0.40 g of boron oxide/polydimethylsiloxane dispersion. Mean particle size of the emulsion was approximately 0.75 μm.

### Example 4

Using the procedure as described in Example 1, a composition prepared from 50 g SiOH functional polydimethylsiloxane having a viscosity of approximately 50,000 mPa sec. (cP) and a number average molecular weight of approximately 61,000, 0.50g of a 50% by weight dispersion of boric acid in trimethylsiloxy-capped polydimethylsiloxane fluid having an approximate kinematic viscosity of 1000 cSt was emulsified using 1.25 g of 60% by weight aqueous sodium secondary alkyl sodium sulfonate (Hostapur® SAS-60) and 5.0 g of water. The resulting thick phase composition was diluted with 27 g of DI water incrementally as described in Example 1. The resulting emulsion consisted of an approximately 60% solids anionic emulsion of PDMS containing 0.5% B₂O₃. Removal of water from this emulsion resulted in a high viscosity polymer.

### Example 5

Using the procedure as described in Example 1, a composition prepared from 50 g SiOH functional polydimethylsiloxane having a viscosity of approximately 50,000 mPa sec. (cP) and a number average molecular weight of approximately 61,000, 0.50 g of a 50% by weight dispersion of boric acid in trimethylsiloxy-capped polydimethylsiloxane fluid having an approximate kinematic viscosity of 1000 cSt was emulsified using 3.3 g of a 30% aqueous solution of cetyltrimethylammonium chloride (CETAC® 30) and 0 g of water. The resulting thick phase was diluted with 30 g of DI water incrementally as described in Example 1. The resulting emulsion consisted of an approximately 60% cationic emulsion of PDMS containing 500 ppm B₂O₃. Removal of water from this emulsion resulted in a film of polymer that had a rubbery consistency.

### Example 6

First, 2 g of α-iso-tridecyl ω-hydroxyl poly(oxythylene) (Lutensol TO12) was added to a 250 mL glass beaker followed by 40 g of deionized water. This surfactant solution was stirred for one hour (150 rpm with a 4-blades metal stirrer on an IKA rotor). 50 g of a SiOH functional siloxane having a viscosity of approximately 50 mPa sec. (cP) and a number average molecular weight of 800 was weighed into a max 100 cup followed by 6.6 g of a 50% by weight dispersion of boric acid in trimethylsiloxy-capped polydimethylsiloxane fluid having an approximate kinematic viscosity of 1000 cS (mm²/s) at 25° C. The cup was closed and placed into a Speedmixer® DAC 150 mixer and the cup was spun for 20 seconds at maximum speed. The contents of the cup were then added in the surfactant solution as described above, and mixed with an Ultraturrax mixer at maximum speed. Then, 0.17 g of stearic acid and 0.18 g of oleic acid were added under gentle stirring (150 rpm with a 4-blades metal stirrer on an IKA rotor). The resulting final composition was a milky-white liquid of low viscosity and consisted of an oil/water emulsion of approximately 60% by weight polydimethylsiloxane containing boron oxide and having a mean particle size of approximately 3.8 μm. The following day, a 20 g portion of the emulsion was poured into an aluminum cup and allowed to evaporate and at ambient conditions for 24 hours. The resulting polymer from the emulsion was inspected and found to have formed a film. The rheological properties of this film were studied using a Carri-med rheometer. The linear-viscoelastic region (LVR) was first determined (torque ramp with a 2 cm 4° steel cone geometry @ 0.2 Hz and 25 C). Then both the storage (G′) and loss module (G″) were determined in this region, G′ was 13600 Pa and G″ was 72400 Pa.

### Example 7

First, 40 g of secondary alkyl sulfonate (hostapur SAS30) at 30% active was weighted in a 500 mL glass beaker followed by 100 g of deionized water. (150 rpm with a 4-blades metal stirrer on an IKA rotor). 300 g of a SiOH functional siloxane having a viscosity of approximately 50 mPa sec. (cP) and a number average molecular weight of approximately 800 was weighed into 500 mL glass beaker followed by 37 g of a 50% by weight dispersion of boric acid in trimethylsiloxy-capped polydimethylsiloxane fluid having a kinematic viscosity of 1000 cS (mm²/s) at 25° C. The mixture was stirred 15 min (150 rpm with a 4-blades metal stirrer on an IKA rotor). This silicone phase was then poured in the surfactant aqueous solution as described above, and stirred for 5 min. The resulting mixture was then processed by one pass at 400 bar in the Rannie® APV system 200. Then, 0.55 g of stearic acid and 0.0.78 g of oleic acid were finally added under gentle stirring (150 rpm with a 4-blades metal stirrer on an IKA rotor). The resulting final composition was a milky-white liquid of low viscosity and consisted of an oil/water emulsion of approximately 60% by weight polydimethylsiloxane containing boron oxide and having a mean particle size of approximately 1.3 um. As described previously, the rheology of the film was studied. The modulus G′ was 2400 Pa and G″ was 28600 Pa.

### Example 8

Using the same procedure and quantities as described in Example 6 except that 1.5 g of the α-iso-tridecyl ω-hydroxyl poly(oxythylene) was replaced by the hexadecyltrimethylammonium chloride at 30% active (Arquad16-29). As described previously, the rheology of the film was studied. The modulus G′ was 29970 Pa and G″ was 112500 Pa.

### Example 9

Using the same procedure and quantities as described in Example 6 except that 4.2 g of the SiOH functional siloxane was replaced by Dow Corning® AP-6087, which is a dimethyl-, methyl-, aminoethylaminoisobutyl, siloxane, having terminal methoxy and hydroxyl functional siloxy groups. The rheology of the film was studied as described previously. The modulus G′ was 3300 Pa and G″ was 29400 Pa.

### Example 10

Using the same procedure and quantities as described in Example 6 except that 0.6 g of the SiOH functional siloxane was replaced by the ethylenediaminepropyl trimethoxysilane. As described previously, the rheology of the film was studied. The modulus G′ was 23300 Pa and G″ was 62000 Pa.

### Example 11

Coatings of a representative dilatant emulsion (labeled herein as DIL Emulsion) and a comparable solvent based composition (labeled herein as X-3180, which Dow Corning® X-3180 polyborosiloxane in propan-2-ol at 65% w/w solids) were impregnated onto a polyester warp-knitted spacer fabric (N2651H Heathcoat Fabrics, Tiverton, UK) using a “dip and squeeze” coating process.

DIL Emulsion, as used in this example was prepared according to the process described in Example 6 above, but using the following ingredients;

1.8 g of α-iso-tridecyl ω-hydroxyl poly(oxythylene) (Lutensol TO12)

60 g of a SiOH functional siloxane having a viscosity of 50 mPa sec

7.6 g of a 50% by weight dispersion of boric acid in trimethylsiloxy-capped polydimethylsiloxane fluid having an kinematic viscosity of 1000 cS (mm²/s) at 25° C.

All other components, processes, and temperatures were the same. The resulting emulsion (DIL Emulsion) had a mean particle size of 2.4 μm. The rheology of the coating from a film of the emulsion was studied as described previously. The modulus G′ was 19900 Pa and G″ was 130 000 Pa.

The “dip and squeeze” coating process involved moving the substrate through a bath of the liquid coating so that the substrate became saturated, then removing excess material until the desired coat weight was achieved by passing the substrate through a nip formed by two moving rollers. The desired coat weight was directly related to the gap between the rollers, thus a smaller gap results in a lower coat weight as more material is squeezed out. Once free of the nip, the substrate was moved into a drying space where volatiles are removed by drying. The line speed used to coat the fabrics in these examples was 0.5 to 1.0 m/min, which resulted in a dried add on weight of approximately 1400 g/m² for each.

The impact attenuation of the coated fabrics was evaluated according to test methods of EN1621-2:1997, which is a “drop-tower” test. A test piece of precise mass and dimensions was dropped from height onto the sample being tested which itself sits upon a force transducer system of precise dimensions and configuration. The kinetic energy specified in the standard was controlled according to the mass and velocity of the moving test piece. The force transmitted through the sample was measured by a piezoelectric detector inside the force transducer that was electronically sampled to produce a record of transmitted force against time. A lower transmitted peak force at a given impact energy indicates better performance. The results are summarized in the following table.

| X-3180 | | X-3180 | | DIL Emulsion | | DIL Emulsion | |
|---|---|---|---|---|---|---|---|
| Impact | Peak | Impact | Peak | Impact | Peak | Impact | Peak |
| Energy | Force | Energy | Force | Energy | Force | Energy | Force |
| J | kN | J | kN | J | kN | J | kN |
| 16.9 | 15.7 | 9.9 | 10.2 | 9.9 | 12.7 | 9.8 | 12.3 |
| 23.0 | 18.7 | 19.9 | 16.1 | 20.2 | 18.3 | 19.9 | 17.1 |
| 29.4 | 20.8 | 29.9 | 19.4 | 30.1 | 22 | 30.3 | 20.8 |
| 42.8 | 25 | 40.0 | 22.1 | 39.6 | 25.7 | 40.0 | 24.4 |
| 50.4 | 27.1 | 49.7 | 25.1 | 49.3 | 30.9 | 49.3 | 28.4 |

### Example 12

First, 2 g of α-iso-tridecyl ω-hydroxyl poly(oxythylene) (Lutensol TO12) was added to a 250 mL glass beaker followed by 24.7 g of deionized water. This surfactant solution was stirred for one hour (150 rpm with a 4-blades metal stirrer on an IKA rotor). 64.5 g of a SiOH functional siloxane having a viscosity of approximately 50 mPa sec. (cP) and a number average molecular weight of 800 was weighed into a max 100 cup followed by 8.2 g of a 50% by weight dispersion of boric acid in trimethylsiloxy-capped polydimethylsiloxane fluid having an approximate kinematic viscosity of 1000 cS (mm²/s) at 25° C. The cup was closed and placed into a Speedmixer® DAC 150 mixer and the cup was spun for 20 seconds at maximum speed. The contents of the cup were then added in the surfactant solution as described above, and mixed with an Ultraturrax mixer at maximum speed. Then, 0.18 g of stearic acid and 0.19 g of oleic acid were added under gentle stirring (150 rpm with a 4-blades metal stirrer on an IKA rotor). The resulting final composition was a white cream and consisted of an oil/water emulsion of approximately 70% by weight polydimethylsiloxane containing boron oxide and having a mean particle size of approximately 2.5 μm.

The following day, a 20 g portion of the emulsion was poured into an aluminum cup and allowed to evaporate and at ambient conditions for 24 hours. The resulting polymer from the emulsion was inspected and found to have formed a film. The rheological properties of this film were studied using a Carri-med rheometer. The linear-viscoelastic region (LVR) was first determined (torque ramp with a 2 cm 4° steel cone geometry @ 0.2 Hz and 25 C). Then a frequency sweep was done at 0.2% strain and the storage (G′) and loss module (G″) were determined at 1 HZ, G′ was 72 000 Pa and G″ was 158 000 Pa.

### Example 13

80 g of an emulsion prepared as described in the emulsion in Example 12, was weighed into a max 100 cup followed by 20 g of colloidal silica LUDOX® AM-30. The cup was closed and placed into a Speedmixer® DAC 150 mixer and the cup was spun for 20 seconds at maximum speed. The resulting milky-white emulsion was poured into an aluminum cup and allowed to evaporate and at ambient conditions for 24 hours. The resulting polymer from the emulsion was inspected and found to have formed a film. The rheological properties of this film were studied using a Carri-med rheometer. The linear-viscoelastic region (LVR) was first determined (torque ramp with a 2 cm 4° steel cone geometry @ 0.2 Hz and 25 C). Then a frequency sweep was done at 0.2% strain and the storage (G′) and loss module (G″) were determined at 1 HZ, G′ was 275 000 Pa and G″ was 358 000 Pa.

### Example 14

90 g of an emulsion prepared as described in the emulsion in the example 10, was weighed into a max 100 cup followed by 10 g of colloidal silica LUDOX® AM-30. The cup was closed and placed into a Speedmixer® DAC 150 mixer and the cup was spun for 20 seconds at maximum speed. The resulting milky-white emulsion was poured into an aluminum cup and allowed to evaporate and at ambient conditions for 24 hours. The resulting polymer from the emulsion was inspected and found to have formed a film. The rheological properties of this film were studied using a Carri-med rheometer. The linear-viscoelastic region (LVR) was first determined (torque ramp with a 2 cm 4° steel cone geometry @ 0.2 Hz and 25 C). Then a frequency sweep was done at 0.2% strain and the storage (G′) and loss module (G″) were determined at 1 HZ, G′ was 127 000 Pa and G″ was 209 000 Pa.

1. An emulsion composition comprising a dilatant boron crosslinked organopolysiloxane.

2. The emulsion composition of claim 1 wherein the emulsion is a water continuous emulsion having a dispersed phase comprising the boron crosslinked organopolysiloxane.

3. The emulsion composition of claim 1 wherein the boron crosslinked organopolysiloxane comprises a reaction product from;
A) a silanol functional organopolysiloxane and
B) a boron compound.

4. The emulsion composition of claim 3 wherein at least 70 percent of the silanol functional groups of component A) are reacted with the boron compound to form the boron crosslinked organopolysiloxane.

5. The emulsion composition of claim 3 wherein the emulsion composition is prepared by a method comprising:
I) forming a mixture of;
A) the silanol functional organopolysiloxane,
B) the boron compound, and
C) an emulsifier,
II) admixing water to the mixture from step I) to form an emulsion,
III) optionally, further shear mixing the emulsion.

6. The emulsion composition of claim 5 wherein the mixture of step I contains
50-99 weight percent A),
0.05-30 weight percent B),
0.10-40 weight percent C),
with the proviso the sum of A), B), and C) is 100 weight percent.

7. The emulsion composition of claim 5 wherein the organopolysiloxane is a silanol terminated polydimethylsiloxane.

8. The emulsion composition of claim 5 wherein the boron compound is dispersed in a trimethylsiloxy terminated polydimethylsiloxane.

9. The emulsion composition of claim 5 wherein the boron compound is B₂O₃ or H₃BO₃.

10. The emulsion composition of 5 wherein the emulsifier is a mixture of nonionic surfactants.

11. The emulsion composition of claim 10 wherein the nonionic surfactant mixture comprises an ethoxylated, C10-Guerbet alcohol or an ethoxylated, iso-C13 alcohol.

12. The emulsion composition of claim 1 wherein the water is admixed in step II in incremental portions.

13. The emulsion composition of claim 1 further comprising colloidal or fumed silica.

14. A method of forming a coating comprising forming a film of the emulsion composition of claim 1 and drying the film to form a coating.

15. The coating prepared by the method of claim 14.

16. The coating of claim 14 wherein the coating has a G′ of at least 200 Pa and a G″ of at least 1000 Pa at 25°.

17. An article of manufacture comprising the coating of claim 14.

18. An article of manufacture according to claim 17 wherein the article is a fabric.

19. The fabric of claim 18 wherein the fabric has an impact attenuation of less than 50 kN peak transmitted force according to EN1621-1 or EN1621-2 impact test methods performed with an impact energy of 50 J.

20. A method of forming a coating comprising forming a film of the emulsion composition of claim 5 and drying the film to form a coating.
